(19) United States
(12) Patent Application Publication
(10) Pub. No.: US 2008/0159356 A1
(43) Pub. Date: Jul. 3, 2008

(54) Method and a system for low-rate channel communication in wireless communication systems

(75) Inventors: Huaning Niu, Sunnyvale, CA (US); Pengfei Xia, Mountain View, CA (US); Chiu Ngo, San Francisco, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/648,468

(22) Filed: Dec. 28, 2006

(51) Int. Cl. H04B 1/69

(52) U.S. Cl. 375/133

(57) ABSTRACT

A method and a system for low-rate bidirectional communications for establishing and maintaining a unidirectional high-rate data link, is provided, wherein orthogonal frequency division multiplexing (OFDM) with spreading is utilized on the low-rate channel. Low-rate communications in an omni-directional mode achieve similar coverage as the high-rate communications in a beamforming mode.

### FIELD OF THE INVENTION

The present invention relates to wireless communication and in particular, to low-rate channel communication in wireless HD communication systems.

### BACKGROUND OF THE INVENTION

With the proliferation of high quality video, an increasing number of electronic devices (e.g., consumer electronic devices) utilize high-definition (HD) video. Conventionally, most devices compress the HD video, which can be more than several Gbps (gigabits per second) in bandwidth, to a fraction of its size to allow for transmission between devices. However, with each compression and subsequent decompression of the video, some video information can be lost and the picture quality is degraded.

The High-Definition Multimedia Interface (HDMI) specification defines an interface for uncompressed HD transmission between devices through the HDMI cables (the wired links). Existing wireless local area networks (WLANs) and similar technologies do not have the bandwidth needed to carry uncompressed HD video, such as providing an air interface to transmit uncompressed video over a 60 GHz bandwidth. Further, existing networks can suffer from interference issues when several devices are connected, leading to video signal degradation.

There is therefore a need for a communication method and system that can support high-rate gigabit per second wireless communications, utilizing a forward link (or data link) for wireless HD communications. There is also a need for a dedicated low-rate control signaling link to establish and to maintain the high-rate forward data link.

### BRIEF SUMMARY OF THE INVENTION

The present invention provides a wireless communication method and a system implementing a low-rate control link (channel) for maintaining a high-rate forward link for wireless HD communications. The high-rate channel is utilized for transmission of uncompressed video or high-rate data in WLANs. Although the low-rate link is mainly for communicating control signals, it can also support other type of signals such as packets of data, audio, video, etc.

In one embodiment, this involves utilizing a low-rate communication model implementing orthogonal frequency division multiplexing (OFDM) with code spreading, for communication over the low-rate control signaling links. In a preferred embodiment, the low-rate communication model includes a symmetric system design, which provides symmetric bidirectional communications between two wireless devices. During a low-rate control signaling session, both devices usually require that data throughput and communication coverage is at roughly the same level. The high-rate data link can be unidirectional, in that during a high-rate data transmission session, one device may function only as the transmitter or a signal source, and the other device may function only as the receiver or signal sink.

These and other features, aspects and advantages of the present invention will become understood with reference to the following description, appended claims and accompanying figures.

### BRIEF DESCRIPTION OF THE DRAWINGS

FIG. 1 shows a functional block diagram of a wireless network that implements low-rate and high-rate channel communication, according to an embodiment of the present invention.

FIG. 2 shows a functional block diagram of an example wireless communication station which implements a low-rate communication model for transmission of control signaling over a low-rate channel in a communication system, according to an embodiment of the present invention.

FIG. 3 shows a diagrammatical example of a symbol repetition process implemented by the wireless communication station of FIG. 2.

FIG. 4 shows an example flowchart of the steps of a low-rate communication model transmission process, according to an embodiment of the present invention.

FIG. 5 shows a functional block diagram of an example receiver on the low-rate channel, according to an embodiment of the present invention.

FIG. 6 shows an example flowchart of the steps of a low-rate communication receiving process, according to an embodiment of the present invention.

### DETAILED DESCRIPTION OF THE INVENTION

The present invention provides a method and a system for communication of control signals and data over low-rate wireless channels and support high-rate data communications, e.g., unidirectional uncompressed video communications, on the forward link. In one embodiment, this involves utilizing a low-rate communication model implementing OFDM with spreading for communication over low-rate wireless channels.

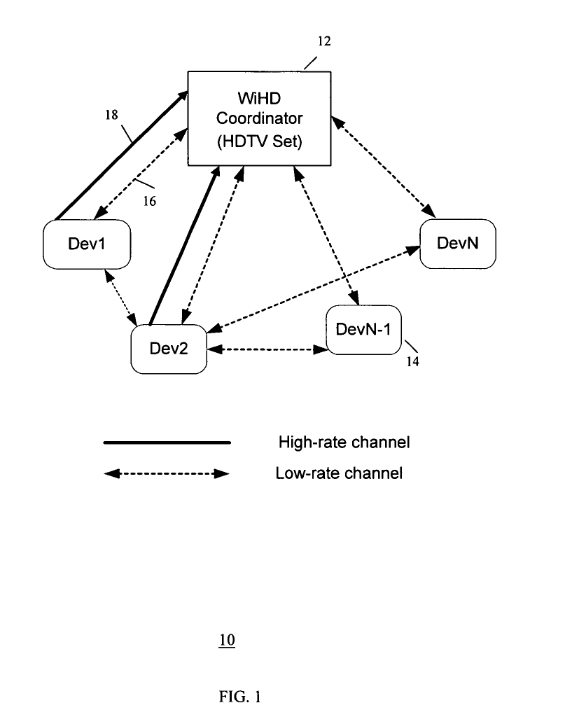

An example implementation of the present invention in conjunction with a wireless HD (WiHD) communication system is now described. FIG. 1 shows a functional block diagram of a wireless network 10 that implements uncompressed HD video transmission between WiHD devices such as a WiHD coordinator 12 and WiHD stations 14 (e.g., Dev1 . . . DevN).

The WiHD stations 14 utilize a low-rate wireless channel 16 (shown by dashed lines in FIG. 1), and may use a high-rate channel 18 (shown by heavy solid lines in FIG. 1), for communication therebetween. The WiHD coordinator 12 uses a low-rate channel 16 and a high-rate wireless channel 18 for communication with the stations 14. Each station 14 uses the low-rate channel 16 for communications with other stations 14. The high-rate channel 18 only supports unicast transmission over directional beams established by beamforming (i.e., the high-rate channel model). In one example, the high-rate channel 18 uses a multi-GB/s bandwidth to support uncompressed HD video transmission. Typically, the high-rate channel is maintained and established by exchange of control signaling over the low-rate channel.

The low-rate channel 16 can support bi-directional transmission with smaller throughput requirement, e.g. with at most 20 Mbps throughput compared to several Gbps throughput requirement on the high-rate channel. The low-rate channel 16 is used to transmit control frames such as acknowledgement (ACK) frames. The low-rate channel can also be used to transmit low-rate data such as audio and/or compressed video.

In this example, the WiHD coordinator 12 is a receiver of video information (hereinafter “receiver 12”) on the high-rate data channel and a WiHD station 14 is a sender of the video information (hereinafter “sender 14”). For example, the receiver 12 can comprise a sink of video and/or audio data, such as a HDTV set in a wireless local area network (WLAN). The sender 14 can be a source of uncompressed video or audio, such as a set-top box, a DVD player, etc., in the WLAN.

Each of the devices 12 and 14 in FIG. 1 is a type of wireless communication station with full transmission and reception capability on the low-rate channel. Therefore, a wireless communication station herein can function as a transmitter/sender, and/or a receiver/responder, on the low-rate channel.

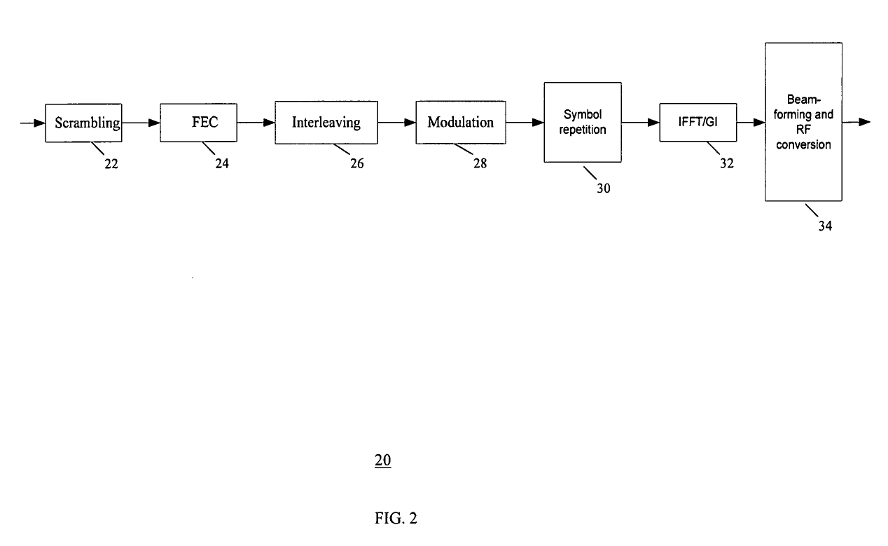

FIG. 2 shows an example functional block diagram of a wireless communication station 20 implementing a low-rate communication model according to the present invention. The example station 20 can work in both beamforming mode as well as in omni-directional mode. When transmitting control signals such as beacons, the station 20 can work in omni-directional transmission mode, providing low-rate signaling, in all directions. When transmitting audio signals or data signals, the station 20 can function in a beamforming mode, providing relatively high-rate data in certain directions only. An omni-directional low-rate transmission from the station 20 has the same coverage (in terms of coverage radius) as a high-rate beamformed transmission.

The station 20 includes a scrambling module 22, a forward error correction (FEC) encoding module 24, an interleaving module 26, a modulation module 28, a symbol repetition module 30, an IFFT (inverse Fast Fourier transform)/GI (guard interval) module 32 and a beamforming and RF module 34 for transmissions over a wireless channel to a receiver station. Although the station 20 includes the beamforming and RF module 34 for high-rate transmissions, the beamforming function of the module 34 is not required for the low-rate sessions according to the present invention.

The scrambling module 22 scrambles incoming bits and the FEC module 24 provides FEC encoding. The encoded bits are then processed in the interleaving module 26 which reshuffles the encoded bits to improve diversity and robustness against excessive channel noise. The modulation module 28 then maps interleaved bits onto constellation symbols that can be transmitted.

The low-rate communication model further provides OFDM modulation in the IFFT/GI module 32, with spreading by the symbol repetition module 30. The IFFT/GI module 32 applies IFFT and guard interval GI window insertion. The symbol repetition module 30 provides symbol repetition using M data sub-carriers and N-times repetition, to explore frequency diversity and spreading gain. This leads to improved physical layer performance that extends the coverage radius of the low-rate communications to be comparable to the coverage radius of the high-rate communications, which implements beamforming techniques.

For high-rate communication over the high-rate channel, the beamforming and RF modulation module 34 performs beamforming steering of data using a beam steering vector. The module 34 then performs necessary radio frequency (RF) operations for wireless transmission.

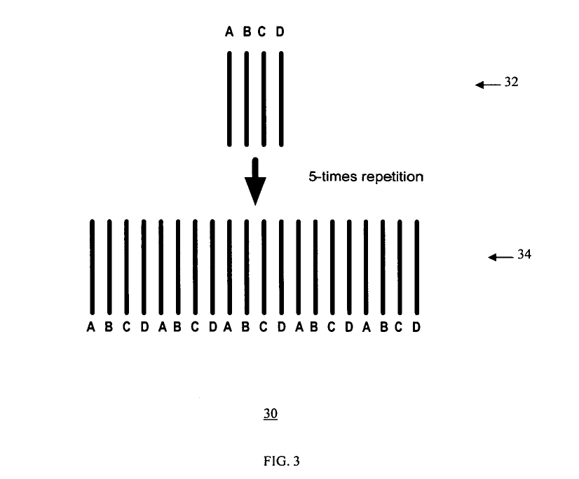

FIG. 3 shows a diagrammatical example of a symbol repetition process 30 implemented by the symbol repetition module 30, using M=4 data sub-carriers and N=5 times repetition. Input data 32 to the symbol repetition module 30 includes data units (symbols) A, B, C, and D as represented by corresponding vertical bars in the upper part of FIG. 3. Each input data unit is repeated 5 times in the output data 34 from the symbol repetition module 30, as shown in the lower part of FIG. 3. Each copy of the same data unit in the input data 32 is evenly distributed across the entire frequency band in the output data 34 for maximum frequency diversity gain. As such, the symbol repetition module 30 repeats each data unit multiple times over the frequency domain. The N-times repetition itself may provide up to 10×log 10(N) dB gain when the receiver provides an essentially optimal combination of the repeated information data. For example, when N=5, a gain of approximately 7 dB may be achieved, depending on the physical environment.

In order to further extend the coverage and to improve the reliability of the low-rate communications, in addition to symbol repetition, a highly reliable modulation scheme (e.g., binary phase shift keying (BPSK)) for the modulation module 28, as well as a highly reliable FEC for the FEC module 24, may be specified, according to further embodiments of the present invention.

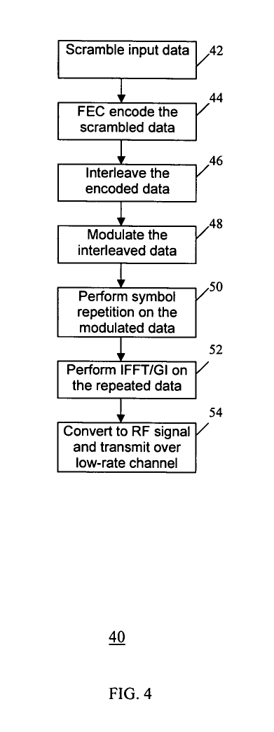

FIG. 4 shows an example flowchart of the steps of a low-rate communication model process 40, according to an embodiment of the present invention, including the steps
Step 42: The scrambling module 22 scrambles incoming bits.
Step 44: The FEC module 24 provides FEC encoding.
Step 46: The encoded bits are then processed in the interleaving module 26 which reshuffles the encoded bits to improve diversity and robustness against excessive channel noise and deep fading.
Step 48: The modulation module 28 then maps the interleaved bits to constellation symbols that can be transmitted.
Step 50: The symbol repetition module 30 provides symbol repetition using M data sub-carriers and N-times (multiple) repetition, to explore frequency diversity and spreading gain.
Step 52: The IFFT/GI module 32 applies IFFT and GI window insertion.
Step 54: The symbol repetition module 30 then performs RF conversion on the data for transmission over a low-rate wireless channel to a receiver.

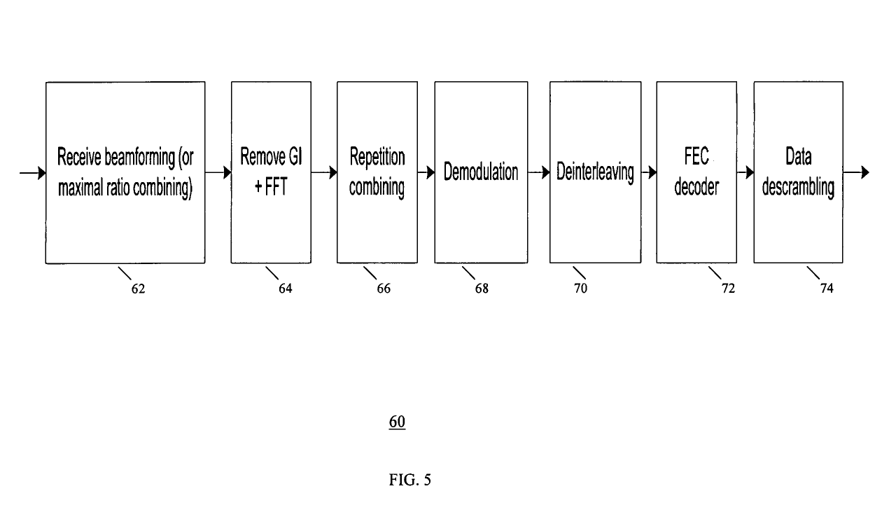

At the receiver front end, the received signal is first converted from a RF signal to a baseband signal and from analog to digital, to allow for faster digital processing. FIG. 5 shows a functional block diagram of an example receiver 60 for the low-rate channel, according to an embodiment of the present invention. A receiver beamforming module 62 may be used for receiving on the low-rate channel. A remove GI & FFT module 64 removes the guard interval in the baseband signal and performs FFT processing on data symbols. A repetition combiner 66 then combines the FFT-processed data symbols in the time domain, so that different repetitions of the same symbol are accumulated together to form a sufficient statistics for optimal processing. A demodulator 68 (e.g., BPSK demodulator) then demaps the combined symbols from constellation symbols to information bits. A deinterleaver 70 then deinterleaves the demapped information bits and a FEC decoder 72 then decodes the deinterleaved information bits. A data descrambler 74 then descrambles the decoded information bits to recover the original information data at the receiver.

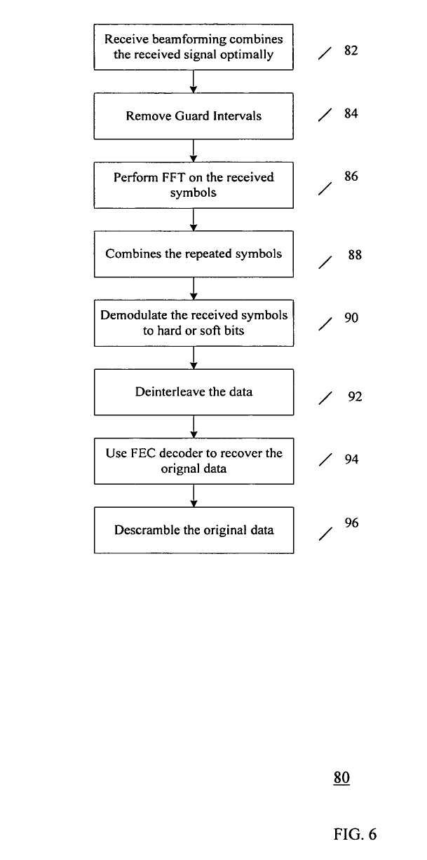

FIG. 6 shows an example process 80 for receiving data on a low-rate communication channel, according to an embodiment of the present invention, which includes the following steps:
Step 82: Optimally combine the signals from a low-rate channel received on different antennas by receive beamforming.
Step 84: Remove Guard Intervals from the received symbols.
Step 86: Perform FFT on the received symbols.
Step 88: The FFT-processed data symbols are then combined in the time domain to derive sufficient statistics for optimum processing.
Step 90: Demodulate the combined symbols by demapping them into information bits (either hard bits or soft bits).
Step 92: Deinterleave the demapped bits to correct bit positions.
Step 94: Decode the deinterleaved bits by FEC decoding.
Step 96: Descramble the decoded bits from scrambling mask to recover the original information.

Table 1 below provides an example of the design parameters for a bi-directional low-rate channel wireless communication model according to the present invention.

TABLE 1
Design Parameters

| Channel bandwidth | 1 GHz |
|---|---|
| Number of subcarriers | 512 |
| Subcarrier spacing | 1G/512 = 1.9531 MHz |
| FFT period | 512 ns |
| Guard interval | 128 ns |
| Symbol duration | 512 + 128 = 640 ns |
| Number of data carriers | 360 |
| Number of DC carriers | 3 |
| Number of pilot carriers | 18 |
| Number of null carriers | 131 |
| Modulation scheme | BPSK |
| Coding (convolutional) | ½ |
| Repetition | 9 |

The parameters in Table 1 are examples, and may be adjusted in different implementation. Examples include slightly smaller bandwidth, larger root mean square (rms) delay spread (DS) which results in a larger GI, etc. The general idea of using repetition (with possibly different repetition patterns) remains the same. To support different data with different priority/importance, such as control signals, multiple spreading gains can also be applied. For example, high priority control packets may be repeated more often than control packets of lower priority.

The cost of specifying such symbol repetition, BPSK modulation and FEC rate increase according to embodiments of the present invention, is additional bandwidth consumption for low-rate communication model. However, such specifications enable same range coverage as provided by beamforming on the high-rate channel.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of wireless communication, comprising the steps of:
inputting data units;
applying spreading to the data units wherein each data unit is repeated multiple times and distributed across the frequency band;
applying orthogonal frequency division multiplexing (OFDM) to the data units; and
transmitting the repeated data units over a low-rate bi-directional wireless channel by omni-directional transmission.

2. The method of claim 1 wherein the step of applying spreading further includes repeating each data unit N times and evenly distributing the repeated data units over M data sub-carriers.

3. The method of claim 1 further comprising the step of encoding the input data units and then reshuffling the encoded data to improve diversity.

4. The method of claim 1 further comprising the step of encoding the input data units before applying OFDM.

5. The method of claim 4 wherein the step of encoding includes applying high-rate FEC encoding to the data units.

6. The method of claim 1 further comprising the step of applying a high reliability modulation scheme to the data units before spreading.

7. The method of claim 6 wherein the modulation scheme comprises BPSK modulation.

8. The method of claim 1 wherein the omni-directional low-rate transmission has the same coverage as a high-rate beamformed transmission.

9. The method of claim 1 wherein the input data units comprise audio information.

10. The method of claim 1 wherein the input data units comprise video information.

11. The method of claim 1 wherein the input data units comprise control information.

12. The method of claim 1 further comprising the steps of:
receiving the repeated data units over a low-rate wireless channel; and
combining the repeated data units such that different repetitions of the same data unit are accumulated together.

13. The method of claim 1 further comprising the steps of:
receiving the repeated data units over a low-rate wireless channel;
performing FFT on the data units; and
combining the repeated data units in the time domain such that different repetitions of the same data unit are accumulated together.

14. The method of claim 3 further comprising the steps of:
receiving the repeated data units over a low-rate wireless channel;
performing FFT on the data units;
combining the repeated data units in the time domain such that different repetitions of the same data unit are accumulated together;
de-shuffling the data units; and
performing decoding on the de-shuffled data units.

15. The method of claim 14 wherein the step of performing decoding further includes the steps of performing FEC decoding.

16. The method of claim 6 further comprising the steps of:
receiving the repeated data units over a low-rate wireless channel;
performing FFT on the data units;
combining the repeated data units in the time domain such that different repetitions of the same data unit are accumulated together; and
applying a high reliability demodulation scheme to the combined data units.

17. The method of claim 16 wherein the step of applying demodulation further includes applying BPSK demodulation.

18. A wireless communication system, comprising:
a wireless transmitter and a wireless receiver, the wireless transmitter including:
a spreading module that is configured to apply spreading to the data units such that each data unit is repeated multiple times and distributed across the frequency band; and
an OFDM module that is configured to apply OFDM to the data units for transmission over a low-rate bi-directional wireless channel by omni-directional transmission.

19. The system of claim 18 wherein the spreading module includes a data unit repetition module that is configured to repeat each data unit N times and evenly distribute the repeated data units over M data sub-carriers.

20. The system of claim 18 wherein the transmitter further includes an encoder that is configured to encode the data units before application of OFDM.

21. The system of claim 20 wherein the encoder is configured to apply a high-rate FEC encoding to the data units.

22. The system of claim 18 wherein the transmitter further includes a modulator that applies a high reliability modulation scheme to the data units before application of spreading by the spreading module.

23. The system of claim 22 wherein the modulator is configured to apply BPSK modulation.

24. The system of claim 18 wherein the omni-directional low-rate transmission has the same coverage as a high-rate beamformed transmission.

25. The system of claim 18 wherein the input data units comprise audio information.

26. The system of claim 18 wherein the input data units comprise video information.

27. The system of claim 18 wherein the input data units comprise control information.

28. The system of claim 18 wherein the OFDM module comprises an interleaver.

29. The system of claim 18 wherein the wireless receiver that is configured to receive the transmitted data units from the low-rate wireless channel.

30. The system of claim 18 further comprising a wireless receiver including:
a receiving module that is configured to receive the repeated data units over a low-rate wireless channel from the transmitter; and
a repetition combiner that is configured to combine the repeated data units such that different repetitions of the same data unit are accumulated together.

31. The system of claim 18 further comprising a wireless receiver including:
a receiving module that is configured to receive the repeated data units over a low-rate wireless channel from the transmitter;
a FFT module that is configured to perform FFT on the data units; and
a repetition combiner that is configured to combine the repeated data units such that different repetitions of the same data unit are accumulated together.

32. The system of claim 28 further comprising a wireless receiver including:
a receiving module that is configured to receive the repeated data units over a low-rate wireless channel from the transmitter;
a FFT module that is configured to perform FFT on the data units;
a repetition combiner that is configured to combine the repeated data units such that different repetitions of the same data unit are accumulated together;
a deinterleaver that deinterleaves the received bits in the data units; and
a decoder that is configured to decode the deinterleaved bits.

33. The system of claim 32 wherein the decoder comprises a FEC decoder.

34. The system of claim 22 further comprising a wireless receiver including:
a receiving module that is configured to receive the repeated data units over a low-rate wireless channel from the transmitter;
a FFT module that is configured to perform FFT on the data units;
a repetition combiner that is configured to combine the repeated data units such that different repetitions of the same data unit are accumulated together; and
a demodulator that demodulates the data units.

35. The system of claim 34 wherein the demodulator comprises a BPSK demodulator.

36. A wireless transmitter comprising:
a spreading module that is configured to apply spreading to the data units such that each data unit is repeated multiple times and distributed across the frequency band; and
an OFDM module that is configured to apply OFDM to data units, for transmission over a low-rate bi-directional wireless channel by omni-directional transmission.

37. The transmitter of claim 36 wherein the spreading module includes a repetition module that is configured to repeat each data unit N times and evenly distribute the repeated data units over M data sub-carriers.

38. The transmitter of claim 36 further including an encoder that is configured to encode the data units before application of OFDM.

39. The transmitter of claim 38 wherein the encoder is configured to apply a high-rate FEC encoding to the data units.

40. The transmitter of claim 36 further including a modulator that applies a high reliability modulation scheme to the data units before application of spreading by the spreading module.

41. The transmitter of claim 36 wherein the modulator is configured to apply BPSK modulation.

42. The transmitter of claim 40 wherein the omni-directional low-rate transmission has the same coverage as a high-rate beamformed transmission.

43. The transmitter of claim 36 wherein the input data units comprise audio information.

44. The transmitter of claim 36 wherein the input data units comprise video information.

45. The transmitter of claim 36 wherein the input data units comprise control information.

46. The transmitter of claim 36 wherein the OFDM module comprises an interleaver.

47. A wireless receiver including:
a receiving module that is configured to receive repeated data units over a low-rate bi-directional wireless channel; and
a repetition combiner that is configured to combine the repeated data units such that different repetitions of the same data unit are accumulated together.

48. A wireless receiver including:
a receiving module that is configured to receive repeated data units over a low-rate bi-directional wireless channel;
a FFT module that is configured to perform FFT on the data units; and
a repetition combiner that is configured to combine the repeated data units such that different repetitions of the same data unit are accumulated together.

49. The receiver of claim 48 further comprising:
a deinterleaver that deinterleaves the received bits in the data units; and
a decoder that is configured to decode the deinterleaved bits.

50. The receiver of claim 49 wherein the decoder comprises a FEC decoder.

51. The receiver of claim 50 further including a demodulator that demodulates the data units.

52. The receiver of claim 51 wherein the demodulator comprises a BPSK demodulator.

53. The receiver of claim 51 wherein each data unit comprises a data symbol.
